(19) United States
(12) Patent Application Publication
(10) Pub. No.: US 2026/0251904 A1
(43) Pub. Date: Aug. 27, 2026

(54) EXTENDED REALITY APPARATUS FOR PERFORMING COLLISION-FREE INTERACTION OF USER IN EXTENDED REALITY ENVIRONMENT AND METHOD FOR OPERATING THE SAME

(71) Applicant: SAMSUNG ELECTRONICS CO., LTD., Suwon-si (KR)

(72) Inventors: Rahul AGRAWAL, Bengaluru (IN); Shivali BHATNAGAR, Bengaluru (IN); Prathmesh Shirish MANURKAR, Bengaluru (IN); Kaushik DAS, Bengaluru (IN)

(73) Assignee: SAMSUNG ELECTRONICS CO., LTD., Suwon-si (KR)

(21) Appl. No.: 19/643,170

(22) Filed: Apr. 9, 2026

Related U.S. Application Data
(63) Continuation of application No. PCT/KR2024/009515, filed on Jul. 4, 2024.

(30) Foreign Application Priority Data
Oct. 10, 2023 (IN) 202341067924

(51) Int. Cl. G02B 27/01; G01S 13/56; G02B 27/00

(52) U.S. Cl. CPC G02B 27/0172; G01S 13/56; G02B 27/0093

(57) ABSTRACT

A method performed by an extended reality (XR) apparatus, may include detecting at least one XR activity of a user from content displayed on the XR apparatus, determining a range of movements of the user in a real-world in response to the at least one XR activity of the user based on content displayed on the XR apparatus, detecting at least one real-world entity in the range of movements of the user in the real-world in response to the at least one XR activity of the user, determining a degree of collision of the at least one real-world entity with the range of movements of the user during the at least one XR activity, and altering the content being displayed on the XR apparatus based on the determined degree of collision of the at least one real-world entity.

### CROSS-REFERENCE TO RELATED APPLICATION

This application is a bypass continuation application of International Patent Application No. PCT/KR2024/009515, filed on Jul. 4, 2024, which claims priority to Indian Patent Application number 202341067924, filed on Oct. 10, 2023, the disclosures of which are incorporated herein by reference in their entireties.

### BACKGROUND

The present disclosure relates to the field of extended Reality (XR) systems and methods, and more particularly to a method and an XR apparatus for collision-free interaction of a user in an XR environment.

Currently, when a user is in a XR session, the user is completely unaware of surrounding objects (e.g., wall, sofa, other person coming or the like) in an XR environment. There are various cases where the user can collide or slip in the XR environment. In an example, a user (e.g., VR headset user or the like) uses static information of the physical environment in a smart home but the VR headset user doesn't account for daily activities performed by other users of the smart home. The VR headset user is a user in a VR session. Even sometimes, the user might select an area which is safe but the activities performed can penetrate that area which can interrupt his/her VR session leading to unpleasant VR experience. It is desired to address the above mentioned disadvantages or other short comings or at least provide a useful alternative.

### SUMMARY

According to an embodiment of the disclosure, disclosed herein is a method, operated by a head-mounted display (HMD) device. The method may include detecting at least one activity of a user from content displayed on the HMD device, determining a range of movements of the user in a real-world based on the at least one activity of the user, detecting at least one real-world object in the range of movements of the user in the real-world in response to the at least one activity of the user, determining a degree of collision of the at least one real-world object with the user during the at least one activity, and changing the content being displayed on the HMD device based on the determined degree of collision of the at least one real-world object.

According to an embodiment of the disclosure, disclosed herein is a head-mounted display (HMD) device. The HMD device may include at least one processor including processing circuitry, and memory storing one or more instructions, when executed by the at least one processor individually or collectively, cause the HMD device to: detect at least one activity of a user based on content displayed on the HMD device; determine a range of movements of the user in a real-world based on the at least one activity of the user; detect at least one real-world object in the range of movements of the user in the real-world; determine a degree of collision of the at least one real-world object with the user during the at least one activity; and change the content being displayed on the HMD device based on the determined degree of collision of the at least one real-world object.

According to an embodiment of the disclosure, disclosed herein is a computer-readable storage medium storing instructions. The instructions, when executed by at least one processor, cause the XR apparatus to perform the method.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the scope thereof, and the example embodiments herein include all such modifications.

### BRIEF DESCRIPTION OF THE DRAWINGS

The above and/or other aspects will be more apparent by describing certain example embodiments, with reference to the accompanying drawings, in which:

FIG. 1 is an example illustration in which a person action during a user's XR session is depicted;

FIG. 2 is an example illustration in which a XR user movement in a wet floor is depicted;

FIG. 3 is an example illustration in which the XR user movement in a living room is depicted;

FIG. 4 illustrates various hardware components of an XR apparatus, according to an embodiment as disclosed herein;

FIG. 5 illustrates various components of the XR apparatus, according to an embodiment as disclosed herein;

FIG. 6 is an example illustration in which an operation of an entity and user identification and monitoring controller is depicted, according to an embodiment as disclosed herein;

FIG. 7 is an example illustration in which identifying user's location and its profile is depicted, according to an embodiment as disclosed herein;

FIG. 8 is an example illustration in which an operation of an entities activities and XR user determination controller is depicted, according to an embodiment as disclosed herein;

FIG. 9 is an example illustration in which an operation of an XR content depth analyzer is depicted, according to an embodiment as disclosed herein;

FIG. 10 is an example illustration in which an operation of a safe zone determination controller is depicted, according to an embodiment as disclosed herein;

FIG. 11 is an example illustration in which an operation of an entity path overlapping predictor is depicted, according to an embodiment as disclosed herein;

FIG. 12 is an example illustration in which an operation of an XR content adjuster is depicted, according to an embodiment as disclosed herein;

FIG. 13A and FIG. 13B are example illustrations in which the XR content adjuster adjusting a rendering depth of an XR session is depicted, according to an embodiment as disclosed herein;

FIG. 14 is an example illustration in which a person action during a user's XR session is depicted, according to an embodiment as disclosed herein;

FIG. 15 is an example illustration in which the XR user movement in the living room is depicted, according to an embodiment as disclosed herein;

FIG. 16 is an example illustration in which a XR user movement in the wet floor is depicted, according to an embodiment as disclosed herein;

FIG. 17 is a flow chart illustrating a method for collision-free interaction of a user in the XR environment, according to an embodiment as disclosed herein;

FIG. 18 is an example flow chart illustrating a method for identifying IoT context and potential boundaries, according to an embodiment as disclosed herein;

FIG. 19 is an example flow chart illustrating a method for detecting a real time movement to set an initial minimum distance threshold and a boundary between the user with the XR user, according to an embodiment as disclosed herein; and

FIG. 20 is an example flow chart illustrating a method for handling the user activity and its physical boundary creation, according to an embodiment as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein may be practiced and to further enable those of skill in the art to practice the example embodiments herein. Accordingly, this disclosure should not be construed as limiting the scope of the example embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It is to be understood that the singular forms “a,” “an,” and “the” include plural referents unless the context clearly dictates otherwise. Thus, for example, reference to “a component surface” includes reference to one or more of such surfaces. It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

In the present disclosure, the term “an embodiment” is intended to encompass one or more embodiments, rather than being limited to a single example. Furthermore, features described in embodiments may be combined and implemented together.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The object of the embodiments herein is to disclose a method and an XR apparatus (e.g., VR headset or the like) for collision-free interaction of a user in an XR environment.

An object of the embodiments herein is to detect and prevent a potential collision in a real world of the user in the XR environment (e.g., smart home XR environment).

An object of the embodiments herein is to monitor a current user activity in the XR apparatus and a range of physical movement in the real-world associated with the user activity.

An object of the embodiments herein is to determine a likelihood of physical interference of one or more real word entities with the physical movement of the user during the user activity in the XR apparatus.

An object of the embodiments herein is to alter the content displayed in the XR apparatus to change the associated range of physical movement in the real-world so as to avoid the physical interference due to movement of real-world entities (e.g., elder person, bed or the like).

An object of the embodiments herein is to enable user to complete his/her XR experience without even knowing outside activities. The activities are precomputed and that information is used later to predict the possible collision with an XR user. The data compute the available safe zone for the XR user and dynamically modifies it by changing the depth perception parameters of the XR apparatus leading to user being confined to dynamic safe zone.

An object of the embodiments herein is to enhance experience of the user while using a XR headset in a smart home, by predicting a potential collision with other entities based on past movement of entities (e.g. users, objects, etc.) and associated actions that are learned over time, and modifying the XR content to change the associated range of physical movement of the user in the real-world so as to avoid the physical interference due to movement of the entities.

The embodiments herein achieve a method for collision-free interaction of a user in an XR environment. The method includes monitoring, by the XR apparatus, at least one current XR activity of a user and a range of physical movements of the user in a real-world associated with at least one current XR activity of the user based on content displayed to the user on the XR apparatus. Further, the method includes determining, by the XR apparatus, a presence of at least one real-world entity in the vicinity of the XR apparatus during the at least one current XR activity of the user. Further, the method includes determining, by the XR apparatus, a degree of collision of the at least one real-world entity with the range of physical movements of the user during the at least one current activity displayed on the XR apparatus. Further, the method includes automatically altering, by the XR apparatus, the content being displayed on the XR display based on the degree of collision of the at least one entity.

Unlike related methods and systems, the proposed method may be used to enable user to complete his/her XR experience without even knowing outside activities. The activities are precomputed and that information is used later to predict the possible collision with an XR user. The data computes the available safe zone for the XR user and dynamically modifies it by changing the depth perception parameters of the XR apparatus leading to user being confined to dynamic safe zone. The proposed method may be used to enhance experience of a user while using a XR headset in a smart home, by predicting a potential collision with other entities based on past movement of entities (e.g. users, objects, etc.) and associated actions that are learned over time, and modifying the XR content to change the associated range of physical movement of the user in the real-world so as to avoid the physical interference due to movement of the entities.

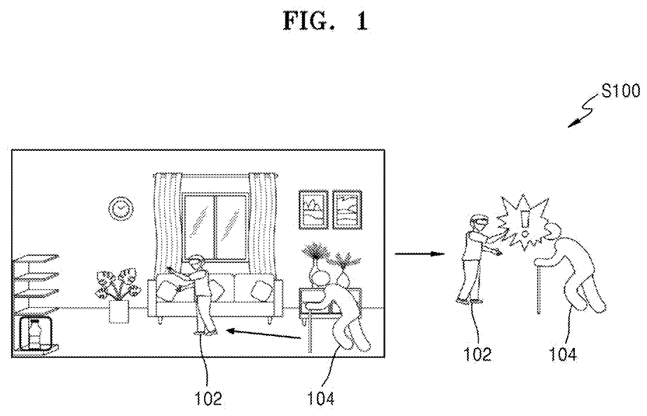

Referring now to the drawings, and more particularly to FIGS. 1 through 20, where similar reference characters denote corresponding features consistently throughout the figures, there are shown example embodiments.

FIG. 1 is an example illustration S100 in which a person action during a user's XR session is depicted.

In an example, when the XR user 102 is in the XR session, the XR headset user 102 is completely unaware of the surrounding objects in the smart home. A person 104 is entering an area, vicinity to the XR user 102, to retrieve a medicinal bottle. Since the XR user 102 is not aware of the surroundings due to the XR session, the XR user 102 might to lead collision with the person 104 who is walking very slowly in the smart home.

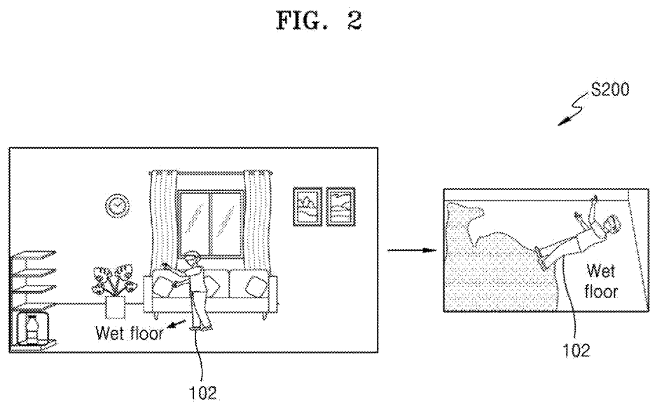

FIG. 2 is an example illustration S200 in which a movement of the XR user 102 in a wet floor is depicted. In an example, a robot cleaner did a mopping job on a floor of the smart home so that the floor is wet, the XR user 102 is completely unaware of the physical environment in the floor, so that the XR user 102 may fall down or slip onto the area where the robot cleaner mopped leading to the wet floor.

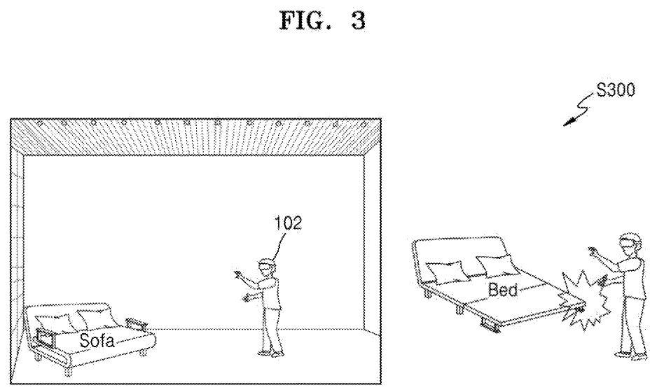

FIG. 3 is an example illustration S300 in which the movement of the XR user 102 in a living room is depicted. In an example, a person watches a TV and he unfolds a sofa into a bed in the smart home while watching the TV, the XR user 102 is completely unaware of the unfolded sofa so that the XR headset user may collide with the bed since lesser space is available in the smart home.

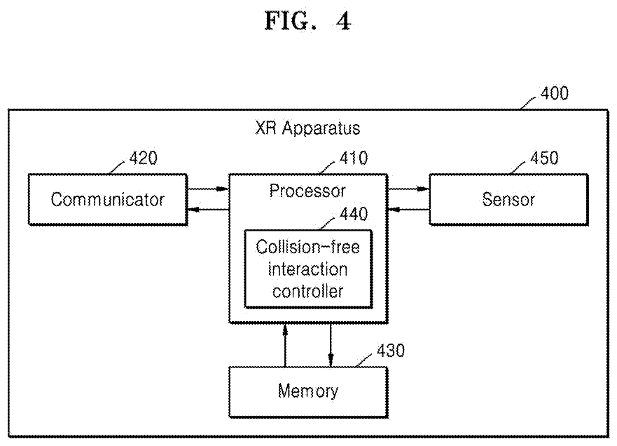

FIG. 4 illustrates various hardware components of an XR apparatus (400), according to an embodiment as disclosed herein. The XR apparatus (400) also known as an Augmented Reality (AR) apparatus, a Mixed Reality (MR) apparatus, a Virtual Reality (VR) apparatus, and a metaverse apparatus. The XR apparatus (400) may be, for example, but not limited to a laptop, a notebook, a Device-to-Device (D2D) device, a vehicle to everything (V2X) device, a smartphone, a XR headset, a foldable phone, a smart TV, a tablet, an immersive device, and an internet of things (IoT) device. In an embodiment, the XR apparatus (400) may be implemented as a head-mounted display (HMD) device. In an embodiment, the XR apparatus (400) may include a processor (410), a communicator (420), a memory (430), a collision-free interaction controller (440), a sensor (450) and a data driven controller. The communicator (420) may be a communication interface implemented by any one or any combination of a digital model, a radio frequency (RF) modem, an antenna circuit, a WiFi chip, and related software and/or firmware. The processor (410) is communicatively coupled with the communicator (420), the memory (430), the collision-free interaction controller (440), the sensor (450) and the data driven controller. Anything described as being done by the collision-free interaction controller (440) below may also be done by the processor (410), by executing the program or at least one instruction stored in the memory (430).

The collision-free interaction controller (440) may store movements of a plurality of real-world entities (e.g. younger person, elder person, pet, dog, foldable sofa or the like) in a geographical area and actions (e.g., walking, sleeping, running, or the like) associated with each entity of the plurality of entities in the geographical area in the memory (430). In an embodiment, the collision-free interaction controller (440) may monitor the movements of the plurality of real-world entities in the geographical area and the actions associated with each entity in the geographical area using multiple angular values from the sensor (450) (e.g., ultra-wideband (UWB) sensor, depth sensor, presence sensor, pressure sensor, or the like) of a plurality of sensors and data generated by an electronic device (e.g., smart phone or the like) of a plurality of electronic devices learned over the period of time using an AI model. Further, the collision-free interaction controllers (440) may store the movements of the plurality of entities in the geographical area and the actions associated with each real-world entity in the geographical area in the memory (430).

Based on content displayed to the user on the XR apparatus (400), the collision-free interaction controller (440) may detect a current XR activity of the user and the range of physical movements of the user in a real-world associated with at least one current XR activity of the user. This may be done by the processor (410) as well.

In an embodiment, the collision-free interaction controller (440) may measure a plurality of entity parameters of the at least one real-world entity using the single or multiple UWB sensors, the radar sensors, but not limited thereto. The plurality of entity parameters may include a height of the real-world entity, a length of the real-world entity, and a speed of movement of the real-world entity. Further, the collision-free interaction controller (440) may determine multiple angular values based on the plurality of real-world entity parameters of the entity. Further, the collision-free interaction controller (440) may detect the real-world entity based on the multiple angular values.

In an embodiment, the collision-free interaction controller (440) may obtain (e.g. receive, download, take) data generated by smart devices available in the geographical area over a period of time. Further, the collision-free interaction controller (440) may detect the content displayed to the user on the XR apparatus (400). Further, the collision-free interaction controller (440) may detect the current activity of the user based on the data generated by the smart devices available in the geographical area and the content displayed to the user on the XR apparatus (400).

Further, the collision-free interaction controller (440) may determine a presence of the real-world entity in the vicinity of the XR apparatus during the current XR activity of the user. Further, the collision-free interaction controller (440) may determine a degree of collision of the real-world entity with the range of physical movements of the user during the current activity displayed on the XR apparatus (400). The degree of collision of the real-world entity may be determined based on the stored movements of the entity in the geographical area and the stored actions associated with the real-world entity in the geographical area. In an embodiment, the collision-free interaction controller (440) may monitor initiation of the current activity of the real-world entity based on the stored actions associated with the entity in the geographical area. Further, the collision-free interaction controller (440) may generate a safe zone of the entity within the geographical area to perform the initiated current activity based on the stored movements of the entity in the geographical area and a depth perception in the XR environment. Further, the collision-free interaction controller (440) may determine the degree of collision the entity with the range of physical movements of the user based on the safe zone.

Further, the collision-free interaction controller (440) may automatically alter the content being displayed on the XR apparatus (400) based on the degree of collision of the entity. In an embodiment, the content being displayed on the XR apparatus (400) may be altered to change the range of physical movements of the user in the geographical area and avoid collision with the entity based on the degree of collision.

In an embodiment, the collision-free interaction controller (440) may determine an occupancy of the user in the geographical area during the current XR activity displayed on the XR apparatus (400). Further, the collision-free interaction controller (440) may generate a radius around the user based on the determined user occupancy in the physical environment. Further, the collision-free interaction controller (440) may detect an entry of the real-world entity within the generated radius around the user. Further, the collision-free interaction controller (440) may predict (e.g. determine, estimate, calculate) the degree of collision of the entity with the range of physical movements of the user when the entity is entered into the radius around the user. Further, the collision-free interaction controller (440) may alter a depth perception in the XR environment for limiting the range of physical movements of the user associated in the geographical area. In an embodiment, the depth perception in the XR environment may be altered by clipping z coordinate of a far viewing plane in the XR environment. In an embodiment, the depth perception in the XR environment may be altered by scaling virtual boundaries of the content displayed on the XR apparatus (400).

The collision-free interaction controller (440) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (410) may be configured to execute instructions stored in a memory (430) and to perform various processes. The memory (430) is associated with the database. The communicator (420) is configured for communicating internally between internal hardware components and with external devices via one or more networks. The memory also stores instructions to be executed by the processor (410). The memory may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted that the memory is non-movable. In certain examples, a non-transitory storage medium may store data that may, over time, change (e.g., in Random Access Memory (RAM) or cache).

Further, at least one of the plurality of modules/controller may be implemented through the AI model using the data driven controller. The data driven controller may be a ML model based controller and AI model based controller. A function associated with the AI model may be performed through the non-volatile memory, the volatile memory, and the processor (410). The processor (410) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (410) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The processor (410) may control overall operation of the device 100 and/or of the set of components of XR apparatus (400) (e.g., the communicator (420), memory (430), collision-free interaction controller (440), and the sensor (450)).

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The one or a plurality of processors may control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic may be made by applying a learning algorithm to a plurality of learning data. The learning may be performed in a device itself in which AI according to an embodiment is performed, and/or may be implemented through a separate server/system.

The AI model may comprise of a plurality of neural network layers. Each layer has a plurality of weight values, and performs a layer operation through calculation of a previous layer and an operation of a plurality of weights. Examples of neural networks may include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm may be a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 4 illustrates various hardware components of the XR apparatus (400) but it is to be understood that other embodiments are not limited thereon. In other embodiments, the XR apparatus (400) may include less or more number of components. Further, the labels or names of the components are used only for illustrative purpose and does not limit the scope of the invention. One or more components may be combined together to perform same or substantially similar function in the XR apparatus (400).

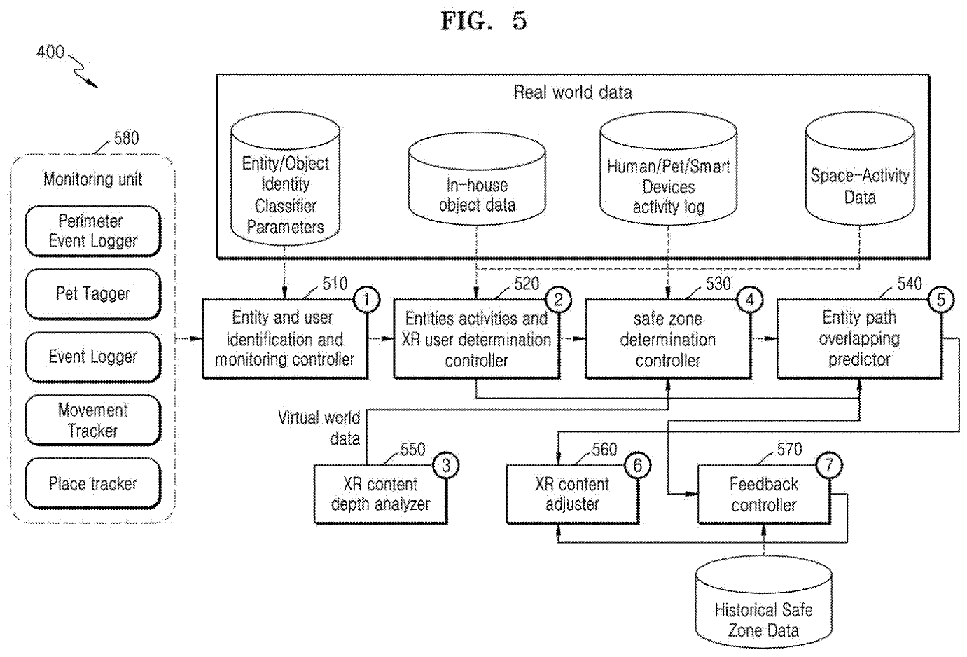

FIG. 5 illustrates various components of the electronic device (400), according to an embodiment as disclosed herein. In an embodiment, the XR apparatus (400) may include an entity and user identification and monitoring controller (510), an entities activities and XR user determination controller (520), a safe zone determination controller (530), an entity path overlapping predictor (540), an XR content depth analyzer (550), an XR content adjuster (560), a feedback controller (570) and a monitoring unit (580). The monitoring controller (510), the entities activities and XR user determination controller (520), the safe zone determination controller (530), the entity path overlapping predictor (540), the XR content depth analyzer (550), the XR content adjuster (560), the feedback controller (570) and the monitoring unit (580) illustrated in FIG. 5 may be implemented by at least one processor included in the XR apparatus 400, executing programs or instructions stored in memory included in the XR apparatus 400. Thus, the operations described herein as being performed by the monitoring controller (510), the entities activities and XR user determination controller (520), the safe zone determination controller (530), the entity path overlapping predictor (540), the XR content depth analyzer (550), the XR content adjuster (560), the feedback controller (570) and the monitoring unit (580) of the XR apparatus 400 may actually be performed by the at least one processor included in the XR apparatus 400.

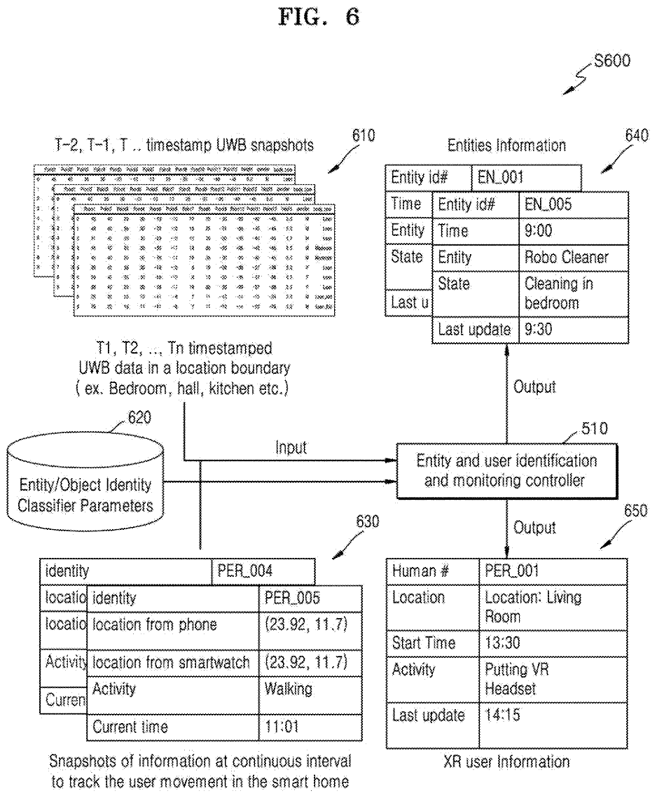

At operation 1 (represented by number \textcircled{1} in FIG. 5, similar in other operations, not repeated), the entity and user identification and monitoring controller (510) may identify and monitor the real-world entities and the user in the smart home by using the monitoring unit (580). The monitoring unit (580) may be, for example, but not limited to a perimeter event logger, a pet tagger, a human tagger, a movement tracker, a location tracker or the like. Example operations of the entity and user identification and monitoring controller (510) are explained in FIG. 6.

The entity and user identification and monitoring controller (510) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

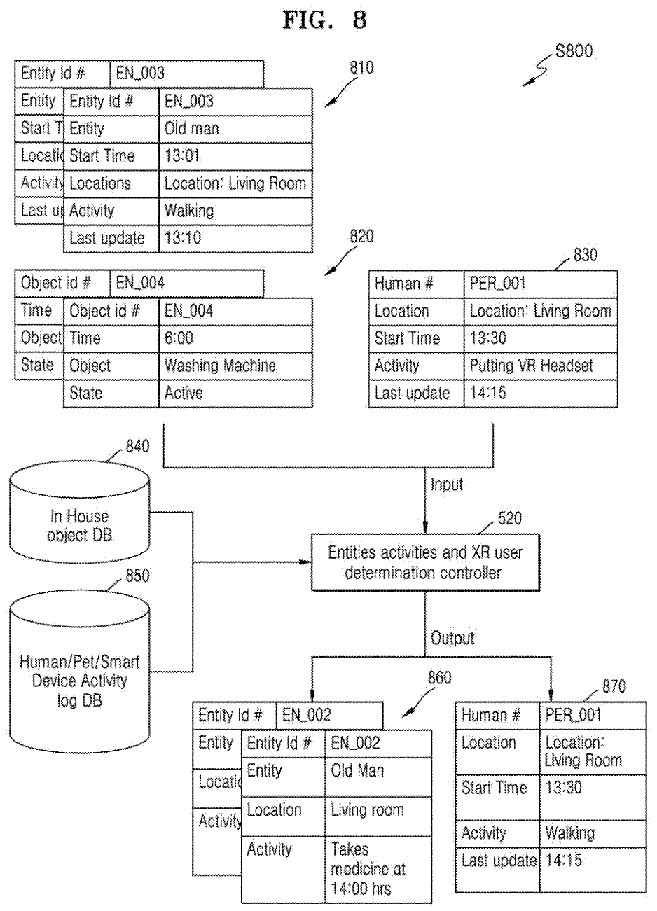

At operation 2, the entities activities and XR user determination controller (520) may determine the possible and ongoing activities by the user and state of entities in the smart home by using a parameter received from a real world data. The parameter may be, for example, but not limited to the entity information, object information, human activity log, pet activity log, smart devices activity log, and space-activity data. Example operations of the entities activities and XR user determination controller (520) are explained in FIG. 8.

The entities activities and XR user determination controller (520) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

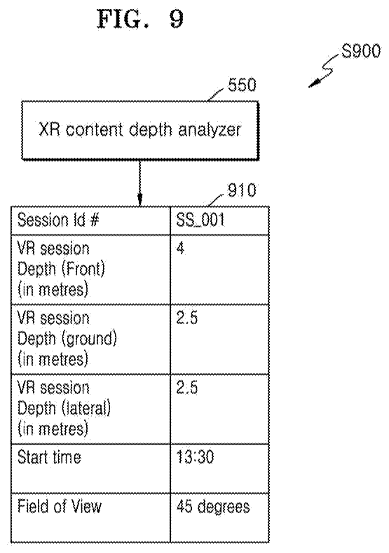

At operation 3, the XR content depth analyzer (550) may analyze the XR environment to perceive initial depth required for the XR session. An example operation of the XR content depth analyzer (550) is explained in FIG. 9. The XR content depth analyzer (550) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

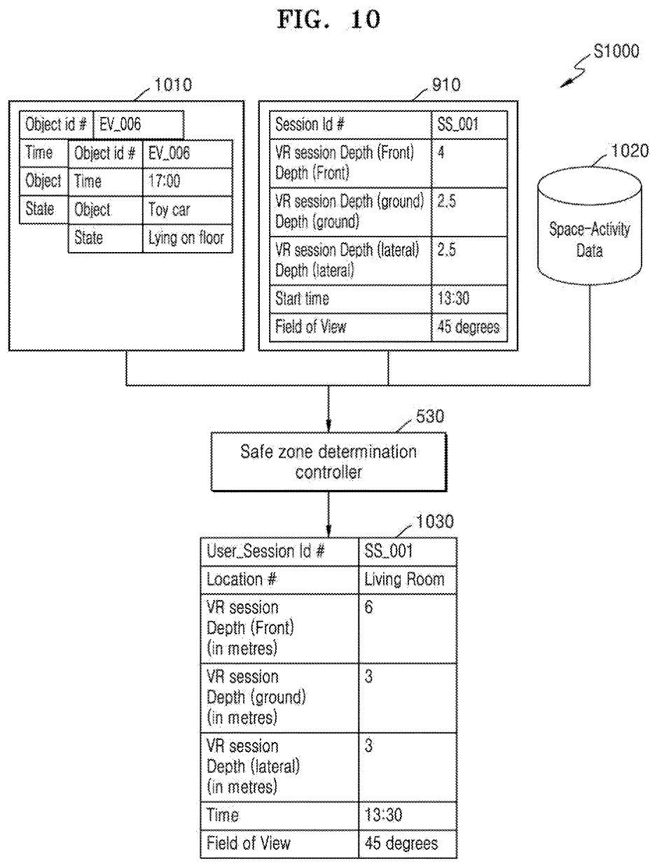

At operation 4, the safe zone determination controller (530) may determine the safe zone for the user in the XR session to safely operate in the smart home. An example operation of the safe zone determination controller (530) is explained in FIG. 10. The safe zone determination controller (530) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

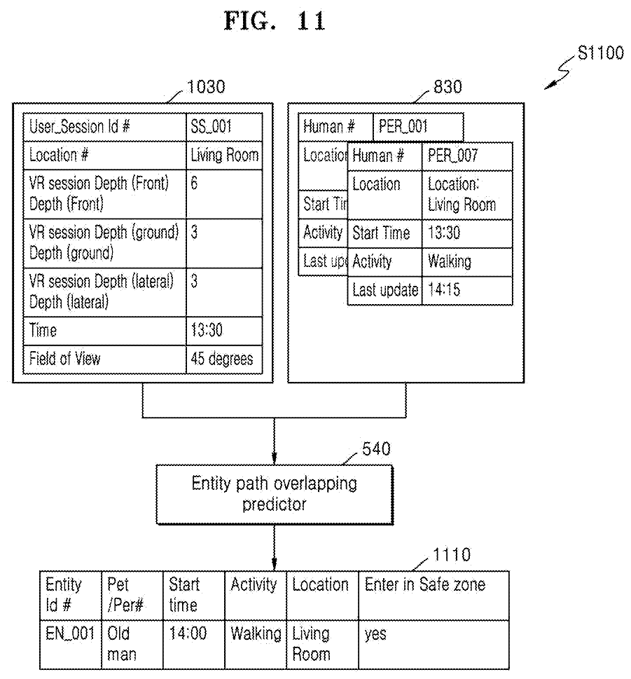

At operation 5, the entity path overlapping predictor (540) may predict (e.g. determine, estimate, calculate) overlapping of real world entity into safe zone by using XR world data and entities activities data. An example operation of the entity path overlapping predictor (540) is explained in FIG. 11. The entity path overlapping predictor (540) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

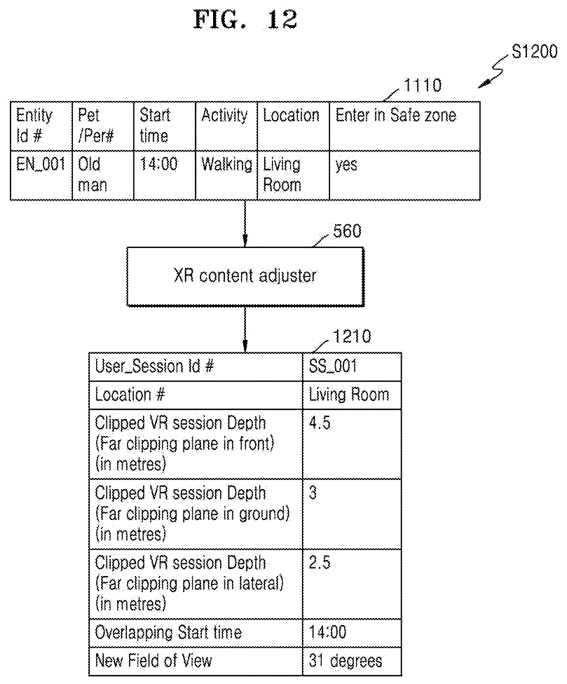

At operation 6, the XR content adjuster (560) adjusts the depth perception of the XR world to keep the user safe. An example operation of the XR content adjuster (560) is explained in FIG. 12. The XR content adjuster (560) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

At operation 7, the feedback controller (570) may improve the overlapping zone detection by using XR world data and entities activities data. The feedback controller (570) may also obtain the historical safe zone data from the memory (430). The feedback controller (570) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Although FIG. 5 illustrates various hardware components included in the electronic device (400) but it is to be understood that other embodiments are not limited thereon. In an embodiment, the electronic device (400) may include less or more number of components. Further, the labels or names of the components are used only for illustrative purpose and does not limit the scope of the invention. One or more components may be combined together to perform same or substantially similar function in the electronic device (400).

FIG. 6 is an example illustration (S600) in which an operation of the real-world entity and user identification and monitoring controller (510) is depicted, according to an embodiment as disclosed herein. The entity and user identification and monitoring controller (510) may take the various timestamp UWB data generated by the monitoring unit (580). In an example, the entity and user identification and monitoring controller (510) may receive the input as T1, T2, . . . , Tn timestamped UWB data in a location boundary (e.g., —bedroom, hall, kitchen etc.) (610), snapshots of information at continuous interval to track the user movement in the smart home (630), and the entity/object identity classifier parameters (620) from the memory (430). Based on inputs (e.g., UWB inputs and others sensors data), the entity and user identification and monitoring controller (510) may classify the type of entity in the smart home. The entity and user identification and monitoring controller (510) may also monitor when the user enters the XR session or not. Further, the entity and user identification and monitoring controller (510) may obtain (e.g. generate) the entities information (640) and the XR user information (650) as an output.

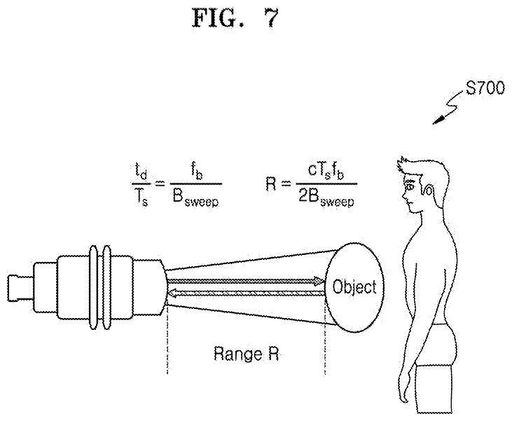

FIG. 7 is an example illustration (S700) in which identifying user's location and its profile are depicted. In a radar sensor based on the Frequency Modulated Continuous Wave (FMCW) technology, the carrier frequency may be constantly modulated within a small range (the bandwidth). As soon as the signal is reflected back from an object, the radar sensor is possible to measure the distance and the speed of the object through frequency comparison. Here the radar sensor emits a frequency (f) which is continuously changed over time (t). In this way, a frequency sweep is created. The difference between minimal and maximal frequency is called bandwidth (Bsweep). The frequency sweep repeats periodically with the sweep time Ts. One modulation type is the sawtooth option as shown in the illustration. As an alternative, triangle wave modulation may be used. The time duration between of this periodically modulation is called sweep time (Ts). During the sweep time, the frequency is continuously increased, e.g. from 122 to 123 GHz. When the emitted radar wave hits an object within the radar cone, a portion of the signal is reflected. This may be detected as an echo signal in the radar sensor. Due to frequency sweep the echo signal has a lower frequency then the emitted signal. The difference between the current frequency and the received frequency (frequency beat fb) is detected by the radar sensor as measured signal. The distance R between radar sensor and object is determined out of the detected frequency sweep (fb), sweep time (Ts) and band width (Bsweep).

There are other sensors available like presence sensors, pressure sensors, UWB sensors, which may be used to detect the properties classify the type, size, position, direction of all moving objects in a smart home location with the help of multi-class classifiers (e.g. Xgboost, decision tree classifier). Calculation of user's location

$$\frac{{t}_{d}}{{T}_{s}} = \frac{{f}_{b}}{{B}_{s w e e p}} , R = \frac{c {T}_{s} {f}_{b}}{2 {B}_{s w e e p}}$$

wherein td=Runtime shift, Ts=Sweep time, R=Range, c=Speed of light, fb=Frequency beat and Bsweep=Bandwidth

FIG. 8 is an example illustration (S800) in which an operation of the entities activities and XR user determination controller (520) is depicted, according to an embodiment as disclosed herein.

The entities activities and XR user determination controller (520) may take the information about the entities (810), objects (820), and humans (830) present in the smart home as well as the past activity records of persons, pets, smart devices during the current time (e.g. In house object DB (840), Human/Pet/Smart Device Activity log DB (850)). The entities activities and XR user determination controller (520) may identify the location and activities of the XR user (870) and the activities of the entities (860). This may help to obtain (e.g. generate, create) the safe zone for the user in the XR environment.

FIG. 9 is an example illustration (S900) in which an operation of the XR content depth analyzer (550) is depicted, according to an embodiment as disclosed herein.

Once the user in the XR session is identified, the XR content depth analyzer (550) may analyze the XR environment and perceive depth (e.g. front, ground, lateral) required by the XR environment. The XR content depth analyzer (550) may obtain (e.g. generate, create) the safe zone and predict (e.g. determine, estimate, calculate) the overlapping of safe zone with real world entities. In an embodiment, the XR content depth analyzer (550) may perceive the information of XR content (e.g. Field of View, start time)

FIG. 10 is an example illustration (S1000) in which an operation of a safe zone determination controller (530) is depicted, according to an embodiment as disclosed herein. The safe zone determination controller (530) may obtain (e.g. generate, create) a virtual safe zone e.g. an area in which the XR user (102) may move without colliding from any object or person (1030) based on past data about entities, depth perception in the XR environment and the space-activity DB. The space-activity DB (1020) includes information about the various activities, in house objects and their locations. The past data about entities (1010) may be obtained by the activities of the entities and XR user determination controller (520), and the depth perception in the XR environment (910) may be obtained by the XR content depth analyzer (550). The virtual safe zone (1030) may include data about user session ID number, location, VR session depth (e.g. front, ground, lateral), time, and field of view, but not limited thereto.

With the details of the user and its properties like walking speed, direction of movement, area covered etc., a restricted boundary may be constructed based on threshold value.

FIG. 11 is an example illustration (S1100) in which an operation of the entity path overlapping predictor (540) is depicted, according to an embodiment as disclosed herein. The entity path overlapping predictor (540) may predict the probable activities of the entities in the smart home and detect if the path of any real world activities overlap with the virtual safe zone and notifies the XR content adjuster (560) for safety of the XR user (102) based on the safe zone area parameters. The entity path overlapping predictor (540) may determine whether person or pet may enter in the safe zone based on the output of the safe zone determination controller (1030) and the information about the humans present in the smart home (830).

FIG. 12 is an example illustration (S1200) in which an operation of the XR content adjuster (560) is depicted, according to an embodiment as disclosed herein. The XR content adjuster (560) may detect the new depth perception (1210) in a virtual reality environment based on the output of the entity path overlapping predictor (1110). It may either clip the z coordinate of the far viewing plane, or scale the rendering environment and the like (1210). In an embodiment, while the XR user (102) required 5 steps to reach a given spot in the virtual world earlier, it only requires 2 steps. In an embodiment, the XR content adjuster (560) may adjust the setting of XR apparatus (400) to control (e.g. restrict, manage) XR user movement.

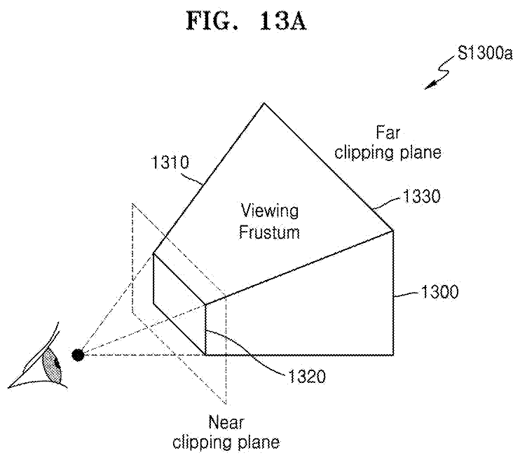

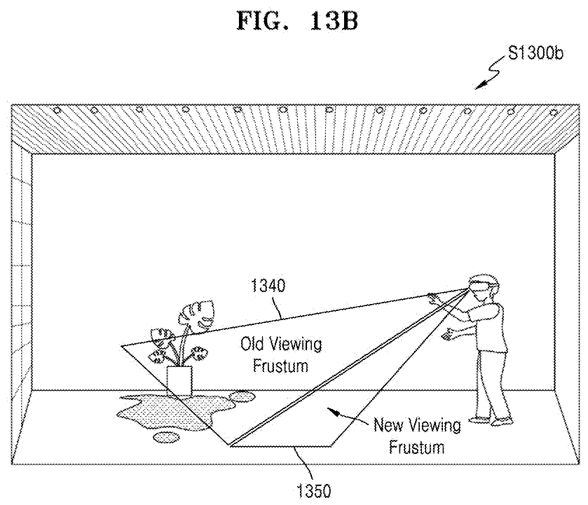

FIG. 13A and FIG. 13B are example illustrations (S1300a and S1300b) in which the XR content adjuster (560) adjusting a rendering depth of the XR session is depicted, according to an embodiment as disclosed herein.

In an example, the XR apparatus (400) setting may be manipulated to modify the View Port, the Field of View (FoV) and scaling of the XR environment to restrict user's movement due to any entity in near vicinity. The ViewPort is basically the screen which gets rendered. The user may change the dimensions of the screen based on the dynamic boundary created in the drivers, thus restricting user's movement. In an example, in OpenGl, glViewport (x,y,w,h), (x,y) represents the lower left corner, while w and h represents the width and height of the rectangular screen to be rendered. Changing the w & h may increase and decrease the size of the screen while translating the (x, y) may shift the screen. The user may also modify the projections. Most of the rendering occurs in perspective projection which consist of the near and far plane. This is known as clipping. Adjusting the z-coordinate of the planes may also assist in implementing dynamic boundaries. Along with the near and far plane, the angle of the frustum (FoV) may be modified. As illustrated in FIG. 13A (S1300a), in Viewing Frustum (1310), the screen in front of the near clipping plane (1320) and behind the far clipping plane (1330) may be clipped. The screen within the range between the near clipping plane (1320) and the far clipping plane (1330) may be rendered. FIG. 13B (S1300b) illustrates the example of the result of clipping (i.e. change in viewing frustum). At old viewing frustum (1340), the XR apparatus (400) infers that there is a wet area which may lead to users slipping on it, hence change the frustum. At new viewing frustum (1350), the XR user's movement is restricted before the wet area. Another way to restrict user's movement is to scale the rendered environment. For example, if initial ratio of the real world coordinates and the virtual World coordinated is 1:1. After scaling, the ratio of the Real World coordinates and Virtual World coordinated is 2:1. This means 1 step in real world will be equal to 2 steps in the XR world, thus user would have to move less to reach to another location and his/her movement may be restricted. These changes may be made in the drivers for the XR apparatus (400) without colliding with third-party applications. Based on the above information, the XR content adjuster (560) adjusting the rendering depth of the XR session as shown in FIG. 13A and FIG. 13B.

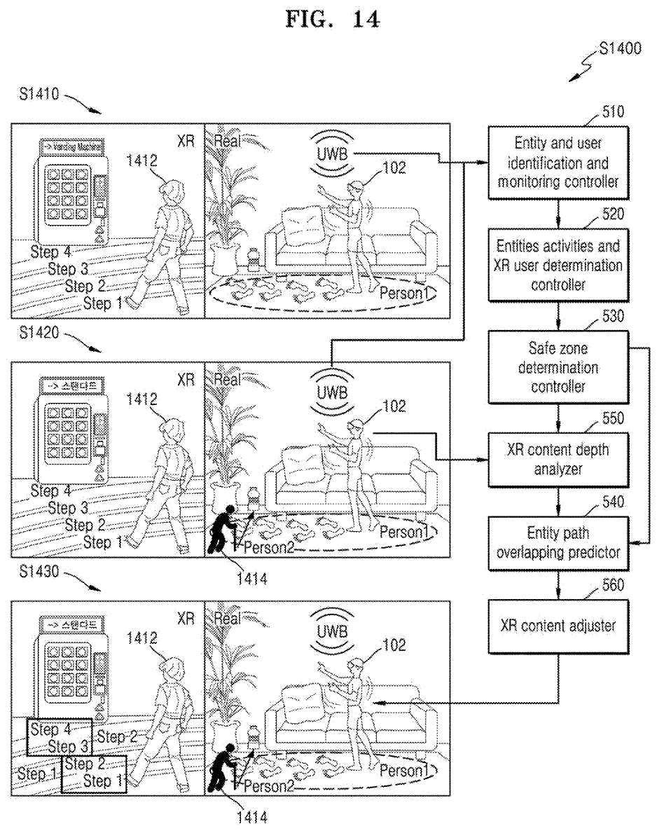

FIG. 14 is an example illustration (S1400) in which an person 2 action during a XR user's XR session is depicted, according to an embodiment as disclosed herein.

As shown in S1410 of the FIG. 14, the XR user (102) (depicted as Person 1 in FIG. 14) was allowed 4 steps in the right direction since there was no other entity present and correspondingly 4 steps were used by the XR avatar (1412) to access a vending machine. As shown in notation S1420 of the FIG. 14, but, the Person 2 (1414) entered into the room to access a bottle across the room whose movement path collides with the XR user (102)'s area.

The entity and user identification and monitoring controller (510) identifies the users in the smart home by using the UWB data. The entities activities and XR user determination controller (520) may detect the Person 2 (1414) entry in the smart home. The safe zone determination controller (530) identifies the safe zone for the Person 1 (102) to operate in the smart home. In an example, the safe zone determination controller (530) identifies the safe zone for Person 1 (102) marked by black boundary allowing him 4 steps in the current direction.

The entity path overlapping predictor (540) identifies the possible intrusion by the person 1 (102). The XR content depth analyzer (550) may analyze the XR content to possibly restrict real movement by the XR. The XR content adjuster (560) may adjust the setting of XR apparatus (400) to adjust (e.g. restrict, manage) XR user movement. Based on the proposed method, the XR user (102) is restricted to 2 steps in current direction to avoid contact with the person 2 (1414) but to keep the XR experience intact 1 step in real world is mapped to 2 steps in the XR session so that the XR avatar (1412) may still access the vending machine, as shown in S1430 of the FIG. 14.

Based on the proposed method, the XR apparatus (400) may change the area of operation of the XR user (102) with the movement path of the Person 2 (1414) to avoid the collision without interrupting the XR session. In an embodiment, repeated descriptions of the S1400 described above with reference to FIG. 5 may be omitted for the sake of brevity.

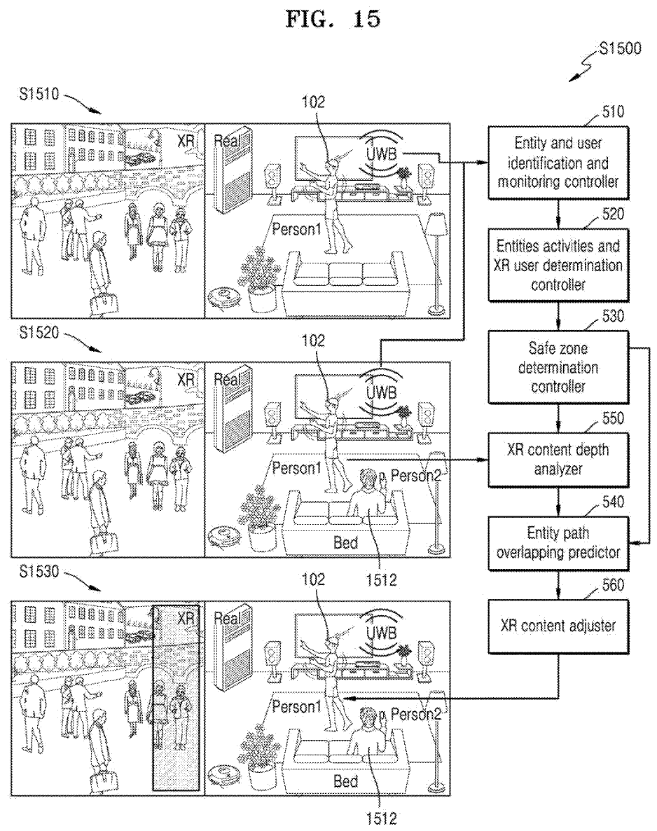

FIG. 15 is an example illustration (S1500) in which the XR user movement in the living room is depicted, according to an embodiment as disclosed herein.

As shown in S1510 of the FIG. 15, the XR user (102) (depicted as Person 1 in FIG. 15) is immersed into the XR session and whole living room is available to him marked by black boundary. As shown in S1520 of the FIG. 15, The person (i.e., person 2 1512) has entered into the living room to watch TV, while doing so the person 2 unfolds the sofa into a bed. The entity and user identification and monitoring controller (510) identifies the users (i.e., person 1 and person 2) in the smart home using UWB data. The entities activities and XR user determination controller (520) detects that the person 2 entry in the smart home. The safe zone determination controller (530) identifies the safe zone for the person 1 (102) to operate in the smart home. In an example, the safe zone determination controller (530) identifies the safe zone for user marked by black boundary. The entity path overlapping predictor (540) identifies the possible intrusion by unfolding of sofa. The XR content depth analyzer (550) may analyze the XR content to possibly restrict real movement by the XR. The XR content adjuster (560) adjusts the rendering depth of XR session by changing settings of XR headset. In an embodiment, the XR content adjuster (560) adjusts the setting of the XR headset to restrict the person 1 (102) movement. Hence, the person 1 (102) (i.e., XR user) is restricted towards the right side (i.e. shaded part in S1530) by hindering the rendering of right side content in the XR world marked by black area in the XR world. In an embodiment, repeated descriptions of the S1500 described above with reference to FIG. 5 may be omitted for the sake of brevity.

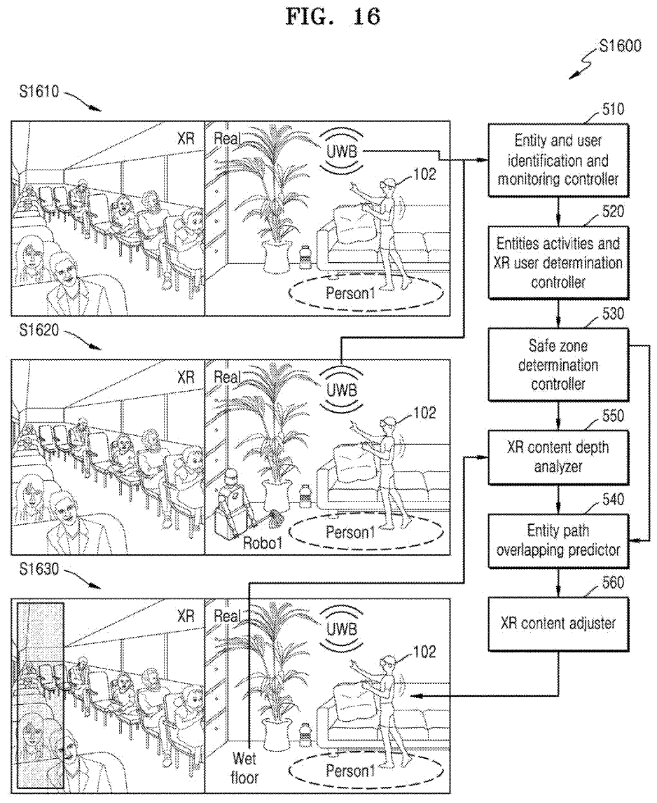

FIG. 16 is an example illustration (S1600) in which a XR user (102) (depicted as Person 1 in FIG. 16) movement in the wet floor is depicted, according to an embodiment as disclosed herein.

Consider, as shown in notation S1610 of the FIG. 16, the XR user (102) is immersed into the XR session and whole living room is available to him marked by black boundary. As shown in notation S1620 of the FIG. 16, The robot cleaner is mopping the floor and will left the area making the floor wet for some time. The entity and user identification and monitoring controller (510) identifies the users in the smart home by using the UWB data.

The entities activities and XR user determination controller (520) detects the mopping by the robot cleaner. The safe zone determination controller (530) identifies the safe zone for Person 1 to operate. The XR content depth analyzer (550) analyzes the XR content to possibly restrict real movement by the XR user (102). The entity path overlapping predictor (540) identifies the area mopped by the robot cleaner to avoid for safe zone identification. The XR content adjuster (560) adjusts the setting of XR apparatus to restrict the XR user movement. In other words, the XR content adjuster (560) adjusts the rendering depth of the XR session by changing settings of the XR apparatus. Hence, the XR user (102) is restricted towards the left side (i.e. shaded part in S1630) by hindering the rendering of left side content in the XR world marked by black area in the XR world, as shown in S1630 of the FIG. 16.

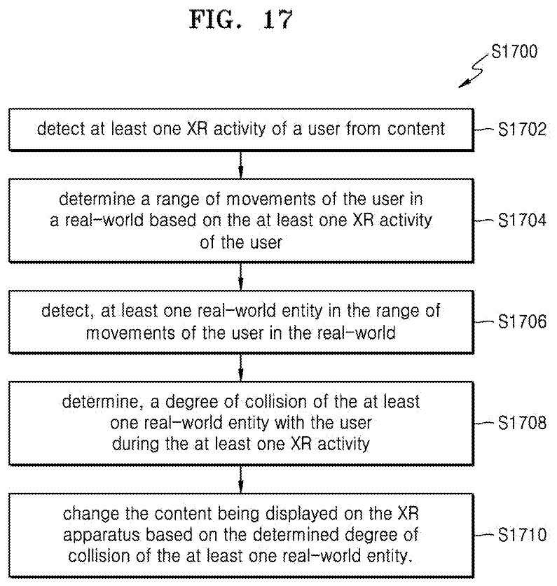

FIG. 17 is a flow chart (S1700) illustrating a method for collision-free interaction of the user in the XR environment, according to an embodiment as disclosed herein. The operations (S1702-S1708) may be performed by the XR apparatus (400).

At S1702, the method includes detecting at least one XR activity of a user from content. At S1704, the method includes determining a range of movements of the user in a real-world based on the at least one XR activity of the user. At S1706, the method includes detecting, at least one real-world entity in the range of movements of the user in the real-world. At S1708, the method includes determining, a degree of collision of the at least one real-world entity with the user during the at least one XR activity. At S1710, the method includes changing the content being displayed on the XR apparatus based on the determined degree of collision of the at least one real-world entity.

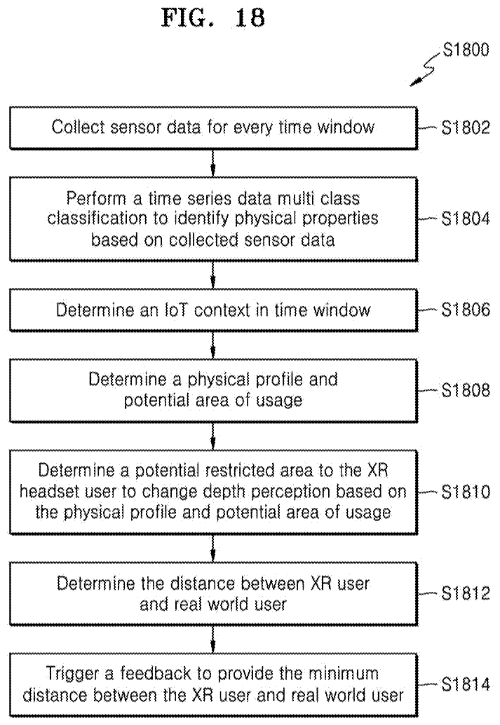

FIG. 18 is an example flow chart (S1800) illustrating a method for identifying the IoT context and potential boundaries, according to an embodiment as disclosed herein. The operations (S1802-S1814) are determined by the XR apparatus (400), particularly by the entities activities and XR user determination controller (520), but not limited thereto.

At S1802, the method may include collecting the sensors data for every time window. At S1804, the method may include performing the time series data multi class classification to identify physical properties based on the collected sensor data. The physical properties may be, for example, but not limited to the Distance information, direction of the object, and direction of the user. At S1806, the method may include determining the IoT context in the time window (for example). In an example, the smart devices data or the historical data may be used to detect the type of activity performed by the users. The IoT context may be determined based on the type of activity.

At S1808, the method may include determining the physical profile and the potential area of usage based on the determined IoT context. The physical profile may be, for example, child behavior profile, old man behavior profile or the like. At S1810, the method may include determining the potential restricted area to the XR headset user to change depth perception based on the physical profile and the potential area of usage. At S1812, the method may include determining the distance between the XR user and the real world user. At S1814, the method may include triggering the feedback to provide the minimum distance between the XR user and the real world user.

In an example, the sensors data collected may be fed to any type of multi classifier model generating multitude of profiles containing the activities. For generating a map between user profiles and potential activities along with the area needed by those activities, following operations may be taken during training to increase accuracy—
The entities activities and XR user determination controller (520) may monitor the signal properties in a location for an extended period of time to classify size, position, direction, speed of all users in location with multi-class classifier (e.g. Xgboost, decision tree classifier or the like)
The entities activities and XR user determination controller (520) may monitor the movement pattern of each physical profile for at least 30 days (for example, but not limited thereto) to generate initial multi-class classification and assigns Person identifier. The system may only consider classifying Person who spend sufficient time in the location.
The data generated by various smart devices belonging to the users may be used to generate better person identification and their activities along with the physical path taken in those activities over the extended period of time.
Based on the physical path, a threshold may be used to maintain the minimum about of distance between a user performing his activity and the XR user (102). This physical boundary information is fed to the XR headset to change the depth perception of user. Depending on the speed of users and direction this threshold value will be modified.
A feedback mechanism will be trigged to analyze the performed activity and its corresponding user's distance with the XR user (102) to refine the threshold value for future such interaction.

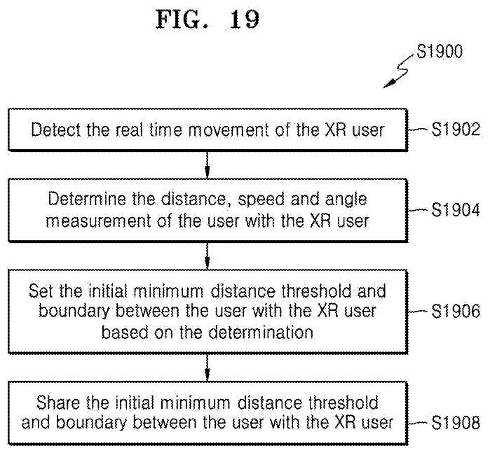

FIG. 19 is an example flow chart (S1900) illustrating a method for detecting the real time movement to set the initial minimum distance threshold and the boundary between the user with the XR user, according to an embodiment as disclosed herein. The operations (S1902-S1908) may be determined by the entity path overlapping predictor (540).

At S1902, the method may include detecting the real time movement of the user. At S1904, the method may include determining the distance, speed and angle measurement of the user with the XR user. At S1906, the method may include setting the initial minimum distance threshold and the boundary between the user with the XR user based on the determination. The initial minimum distance threshold is set by the XR user or the XR apparatus (400). At S1908, the method may include sharing the initial minimum distance threshold and boundary between the user.

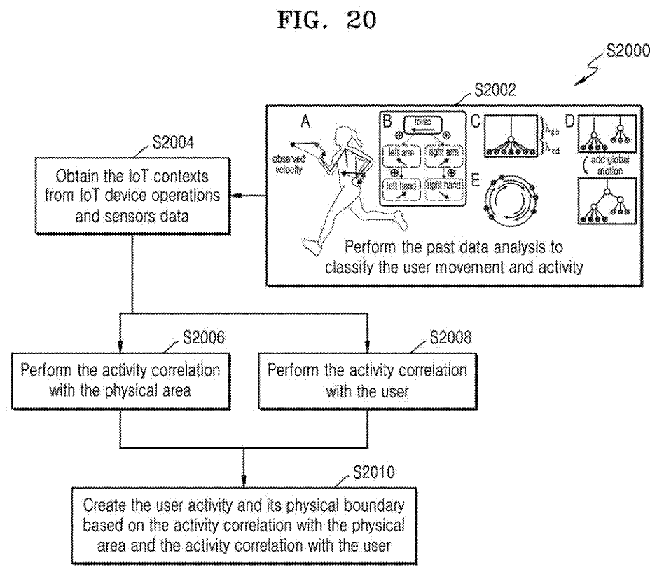

FIG. 20 is an example flow chart (S2000) illustrating a method for handling the user activity and its physical boundary creation, according to an embodiment as disclosed herein. The operations (S2002-S2010) may be determined by the entities activities and XR user determination controller (520).

At S2002, the method may include performing the past data analysis to classify the user movement and the user activity. The user activity may be, for example, but not limited to walking, exercising and cleaning floor. At S2004, the method may include obtaining the IoT contexts from the IoT device operations (e.g., TV watching, listening the music or the like) and the sensors data. At S2006, the method may include performing the activity correlation with the physical area. At S2008, the method may include perform the activity correlation with the user. At S2010, the method may include creating the user activity and its physical boundary based on the activity correlation with the physical area and the activity correlation with the user.

The various actions, acts, blocks, steps, or the like in the flow charts (S1700-S2000) may be performed in the order presented, in a different order or simultaneously. Further, in some embodiments, some of the actions, acts, blocks, steps, or the like may be omitted, added, modified, skipped, or the like without departing from the scope of the invention.

Accordingly, the embodiments herein disclose a method for collision-free interaction of a user in an XR environment. The method may include detecting, by a head-mounted display (HMD) device, at least one current activity of a user and a range of physical movements of the user in a real-world associated with at least one current activity of the user based on content displayed to the user on the HMD device. The method may include determining a presence of at least one real-world object in the vicinity of the HMD device during the at least one current activity of the user. The method may include determining a degree of collision of the at least one real-world object with the user during the at least one current activity. The method may include changing the content being displayed on the XR display based on the degree of collision of the at least one object.

In an embodiment, the content being displayed on the HMD device may be altered to change the range of movements of the user in the geographical area and avoid the collision with the at least one real-world object based on the determined degree of collision.

In an embodiment, the content being displayed on the HMD device may be altered to change the range of physical movements of the user in the geographical area and avoid collision with the at least one real-world object based on the determined degree of collision.

In an embodiment, changing of the content being displayed on the XR display based on the determined degree of collision of the at least one real-world object may include determining a position of the user in the geographical area during the at least one activity displayed on the HMD device. The method may include determining a radius around the user based on the determined position of the user in the real-world area. The method may include detecting the at least one real-world object within the determined radius around the user. The method may include predicting the degree of collision of the at least one real-world object with the user based on the determination that the at least one real-world object is within the radius around the user. The method may include changing a depth perception in XR environment for changing the range of movements of the user in a geographical area.

In an embodiment, automatically changing of the content being displayed on the XR display based on the determined degree of collision of the at least one real-world object may include determining an occupancy of the user in the geographical area during the at least one current activity. The method may include generating a radius around the user based on the determined user occupancy in the physical environment. The method may include detecting an entry of the at least one real-world object within the generated radius around the user. The method may include predicting the degree of collision of the at least one real-world object with the range of physical movements of the user when the at least one real-world object is entered into the radius around the user. The method may include changing a depth perception in the XR environment for limiting the range of physical movements of the user associated in a geographical area.

In an embodiment, the depth perception in the XR environment may be altered by clipping z coordinate of a far viewing plane in the XR environment. The depth perception in the XR environment may be altered by scaling virtual boundaries of the content.

In an embodiment, the at least one real-world object may be detected by measuring a plurality of object parameters of the at least one object. The at least one real-world object may be detected by determining multiple angular values based on the plurality of object parameters of the at least one object. The at least one real-world object may be detected by detecting the at least one object based on the multiple angular values. The plurality of object parameters may include at least one of a height of the at least one object, a length of the at least one object, or a speed of movement of the at least one object.

In an embodiment, the at least one real-world object may be detected by measuring a plurality of object parameters of the at least one object using a single or multiple Ultra-wideband (UWB) sensors or radar sensors. The at least one real-world object may be detected by determining multiple angular values based on the plurality of object parameters of the at least one object. The at least one real-world object may be detected by detecting the at least one object based on the multiple angular values. The plurality of object parameters may include a height of the at least one object, a length of the at least one object, and a speed of movement of the of the at least one object.

In an embodiment, detecting of the at least one activity of the user based on the content may include obtaining data generated by external devices in the geographical area. The detecting of the at least one activity of the user based on the content may include detecting the content displayed on the HMD device. The detecting of the at least one activity of the user based on the content may include detecting the at least one current activity of the user based on the data generated by external devices in the geographical area and the content.

In an embodiment, monitoring, by the HMD device, the at least one current activity of the user based on the content may include receiving data generated by smart devices available in the geographical area over a period of time. The detecting of the at least one current activity of the user based on the content may include detecting the content displayed to the user on the HMD device. The detecting of the at least one current activity of the user based on the content may include monitoring the at least one current activity of the user based on the data generated by smart devices available in the geographical area and the content.

In an embodiment, determining of the degree of collision of the at least one real-word object with the range of movements of the user during the at least one activity may include detecting initiation of the at least one activity of the at least one object based on the stored actions of the at least one object in the geographical area. The degree of collision of the at least one real-word object with the range of movements of the user during the at least one activity may include obtaining a safe zone of the at least one object within the geographical area to perform the at least one initiated activity based on the stored actions of the at least one object in the geographical area and a depth perception in the XR environment. The degree of collision of the at least one real-word object with the range of movements of the user during the at least one activity may include determining the degree of collision the at least one object with the range of movements of the user based on the safe zone.

In an embodiment, determining of the degree of collision of the at least one real-word object with the range of physical movements of the user during the at least one current activity displayed on the HMD device may include monitoring initiation of the at least one current activity of the at least one object based on the stored actions associated with at least one object in the geographical area. The degree of collision of the at least one real-word object with the range of physical movements of the user during the at least one current activity displayed on the HMD device may include creating a safe zone of the at least one object within the geographical area to perform the at least one initiated current activity based on the stored movements of the at least one object in the geographical area and a depth perception in the XR environment. The degree of collision of the at least one real-word object with the range of physical movements of the user during the at least one current activity displayed on the HMD device may include determining the degree of collision the at least one object with the range of physical movements of the user based on the safe zone.

Accordingly, the embodiments herein disclose a head-mounted display (HMD) device for collision-free interaction of a user in an XR environment. The HMD device may include a database including an XR application, at least one processor including processing circuitry, a collision-free interaction controller communicatively coupled to the database and the processor, and memory storing one or more instructions. The one or more instructions, when executed by the at least one processor individually or collectively, cause the HMD device to detect at least one current activity of a user and a range of physical movements of the user in a real-world associated with at least one current activity of the user based on content displayed to the user on a HMD device. The one or more instructions, when executed by the at least one processor individually or collectively, cause the HMD device to determine a presence of at least one real-world object in the vicinity of the HMD device during the at least one current activity of the user. The one or more instructions, when executed by the at least one processor individually or collectively, cause the HMD device to determine a degree of collision of the at least one real-world object with the user during the at least one current activity. The one or more instructions, when executed by the at least one processor individually or collectively, cause the HMD device to change the content being displayed on the XR display based on the determined degree of collision of the at least one real-world object. In an embodiment, the content may be altered to change the range of movements of the user in the geographical area and avoid the collision with the at least one real-world object based on the determined degree of collision.

In an embodiment, the content being displayed on the HMD device may be altered to change the range of physical movements of the user in the geographical area and avoid the collision with the at least one real-world object based on the determined degree of collision.

In an embodiment, the one or more instructions, when executed by the at least one processor individually or collectively, cause the HMD device to determine a position of the user in the geographical area during the at least one activity displayed on the HMD device. In an embodiment, the one or more instructions, when executed by the at least one processor individually or collectively, cause the HMD device to determine a radius around the user based on the determined position of the user in the real-world area. In an embodiment, the one or more instructions, when executed by the at least one processor individually or collectively, cause the HMD device to detect the at least one real-world object within the determined radius around the user. In an embodiment, the one or more instructions, when executed by the at least one processor individually or collectively, cause the HMD device to predict the degree of collision of the at least one real-world object with the range of movements of the user based on the determination that the at least one real-world object is within the radius around the user. In an embodiment, the one or more instructions, when executed by the at least one processor individually or collectively, cause the HMD device to change a depth perception in XR environment for changing the range of movements of the user in the geographical area.

In an embodiment, the one or more instructions, when executed by the at least one processor individually or collectively, cause the HMD device to determine an occupancy of the user in the geographical area during the at least one current activity displayed on the HMD device. In an embodiment, the one or more instructions, when executed by the at least one processor individually or collectively, cause the HMD device to generate a radius around the user based on the determined user occupancy in the physical environment In an embodiment, the one or more instructions, when executed by the at least one processor individually or collectively, cause the HMD device to detect an entry of the at least one real-world object within the generated radius around the user. In an embodiment, the one or more instructions, when executed by the at least one processor individually or collectively, cause the HMD device to predict the degree of collision of the at least one real-world object with the range of physical movements of the user when the at least one real-world object is within the radius around the user. In an embodiment, the one or more instructions, when executed by the at least one processor individually or collectively, cause the HMD device to change a depth perception in the XR environment for limiting the range of physical movements of the user associated in the geographical area.

In an embodiment, the depth perception in the XR environment may be altered by clipping z coordinate of a far viewing plane in the XR environment. In an embodiment, the depth perception in the XR environment may be altered by scaling virtual boundaries of the content.

In an embodiment, the one or more instructions, when executed by the at least one processor individually or collectively, cause the HMD device to detect the at least one real-world object by measuring a plurality of real-world object parameters of the at least one real-world object, wherein the plurality of object parameters comprises at least one of a height of the at least one real-world object, a length of the at least one real-world object, or a speed of movement of the at least one real-world object. The one or more instructions, when executed by the at least one processor individually or collectively, cause the HMD device to detect the at least one real-world object by determining a plurality of angular values based on the plurality of real-world object parameters of the at least one real-world object. The at least one real-world object may be detected by detecting the at least one real-world object based on the plurality of angular values.

In an embodiment, the one or more instructions, when executed by the at least one processor individually or collectively, cause the HMD device to detect the at least one real-world object by measuring a plurality of real-world object parameters of the at least one real-world object using a single or multiple UWB sensors or radar sensors, wherein the plurality of object parameters comprises a height of the at least one real-world object, a length of the at least one real-world object, and a speed of movement of the at least one real-world object.

In an embodiment, the one or more instructions, when executed by the at least one processor individually or collectively, cause the HMD device to obtain data generated by external devices in the geographical area. The one or more instructions, when executed by the at least one processor individually or collectively, cause the HMD device to detect the content. The one or more instructions, when executed by the at least one processor individually or collectively, cause the HMD device to detect the at least one activity of the user based on the data generated by external devices in the geographical area and the content.

In an embodiment, one or more instructions, when executed by the at least one processor individually or collectively, cause the HMD device to receive data generated by smart devices available in a geographical area over a period of time. The one or more instructions, when executed by the at least one processor individually or collectively, cause the HMD device to detect the content displayed to the user on the HMD device. The one or more instructions, when executed by the at least one processor individually or collectively, cause the HMD device to monitor the at least one current activity of the user based on the data generated by smart devices available in the geographical area and the content.

In an embodiment, the one or more instructions, when executed by the at least one processor individually or collectively, cause the HMD device to detect initiation of the at least one activity of the at least one real-world object based on stored actions of the at least one real-world object in the geographical area. The one or more instructions, when executed by the at least one processor individually or collectively, cause the HMD device to obtain a safe zone of the at least one real-world object within the geographical area to perform the at least one activity based on the stored actions of the at least one object in the geographical area and a depth perception in the XR environment. The one or more instructions, when executed by the at least one processor individually or collectively, cause the HMD device to determine the degree of collision the at least one real-world object with the range of movements of the user based on the safe zone.

In an embodiment, the one or more instructions, when executed by the at least one processor individually or collectively, cause the HMD device to monitor initiation of the at least one current activity of the at least one real-world object based on stored actions associated with the at least one real-world object in the geographical area. determining the degree of collision of the at least one real-world object with the range of physical movements of the user during the at least one current activity displayed on the HMD device creating a safe zone of the at least one real-world object within the geographical area to perform the at least one initiated current activity based on the stored movements of the at least one object in the geographical area and a depth perception in the XR environment. The one or more instructions, when executed by the at least one processor individually or collectively, cause the HMD device to determine the degree of collision the at least one real-world entity with the range of physical movements of the user based on the safe zone.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the scope of the embodiments as described herein.

What is claimed is:

1. A method performed by ahead mounted display (HMD) device, the method comprising:
detecting at least one activity of a user from content displayed on the HMD device;
determining a range of movements of the user in a real-world based on the at least one activity of the user;
detecting at least one real-world object in the range of movements of the user in the real-world;
determining a degree of collision of the at least one real-world object with the user during the at least one activity; and
changing the content being displayed on the HMD device based on the determined degree of collision of the at least one real-world object.

2. The method as claimed in claim 1, wherein the content is altered to change the range of movements of the user in a geographical area and avoid the collision with the at least one real-world object based on the determined degree of collision.

3. The method as claimed in claim 1, wherein the changing of the content comprises:
determining a position of the user in a geographical area during the at least one activity displayed on the HMD device;
determining a radius around the user based on the determined position of the user in the real-world;
detecting the at least one real-world object within the determined radius around the user;
predicting the degree of collision of the at least one real-world object with the range of movements of the user based on the at least one real-world object being determined to be within the radius around the user; and
altering a depth perception in environment for changing the range of movements of the user in the geographical area.

4. The method as claimed in claim 3, wherein the depth perception in the environment is altered by at least one of:
clipping a z coordinate of a far viewing plane in the environment, or
scaling virtual boundaries of the content.

5. The method as claimed in claim 1, wherein the detecting of the at least one real-world object comprises:
measuring a plurality of real-world object parameters of the at least one real-world object, wherein the plurality of real-world object parameters comprises at least one of a height of the at least one real-world object, a length of the at least one real-world object, or a speed of movement of the at least one real-world object;
determining a plurality of angular values based on the plurality of real-world object parameters of the at least one real-world object; and
detecting the at least one real-world object based on the plurality of angular values.

6. The method as claimed in claim 1, wherein the detecting of the at least one activity of the user comprises:
obtaining data generated by external devices in a geographical area;
detecting the content; and
detecting the at least one activity of the user based on the data generated by the external devices in the geographical area and the content.

7. The method as claimed in claim 1 wherein the determining of the degree of collision of the at least one real-world object comprises:
detecting initiation of the at least one activity of the at least one real-world object based on stored actions of the at least one object in a geographical area;
obtaining a safe zone of the at least one real-world object within the geographical area to perform the at least one initiated activity based on the stored actions of the at least one object in the geographical area and a depth perception in the XR environment; and
determining the degree of collision of the at least one object with the range of movements of the user based on the safe zone.

8. A head-mounted display (HMD) device comprising:
at least one processor including processing circuitry;
memory storing one or more instructions, when executed by the at least one processor individually or collectively, cause the HMD device to:
detect at least one activity of a user based on content displayed on the HMD device;
determine a range of movements of the user in a real-world based on the at least one activity of the user;
detect at least one real-world object in the range of movements of the user in the real-world;
determine a degree of collision of the at least one real-world object with the user during the at least one activity; and
change the content being displayed on the HMD device based on the determined degree of collision of the at least one real-world object.

9. The HMD device as claimed in claim 8, wherein the content being displayed on the HMD device is altered to change the range of movements of the user in a geographical area and avoid the collision with the at least one real-world object based on the determined degree of collision.

10. The HMD device as claimed in claim 8, wherein the one or more instructions, when executed by the at least one processor individually or collectively, cause the HMD device to:
determine a position of the user in a geographical area during the at least one activity displayed on the HMD device;
determine a radius around the user based on the determined position of the user in the real-world;
detect the at least one real-world object within the determined radius around the user;
predict the degree of collision of the at least one real-world object with the range of movements of the user based on the determination that the at least one real-world object is within the radius around the user; and
change the content by alternating a depth perception in environment for changing the range of movements of the user in the geographical area.

11. The HMD device as claimed in claim 10, wherein the depth perception in the environment is altered by at least one of:
clipping a z coordinate of a far viewing plane in the environment, or
scaling virtual boundaries of the content.

12. The HMD device as claimed in claim 8, wherein the one or more instructions, when executed by the at least one processor individually or collectively, cause the HMD device to:
measure a plurality of real-world object parameters of the at least one real-world object, wherein the plurality of object parameters comprises at least one of a height of the at least one real-world object, a length of the at least one real-world object, or a speed of movement of the at least one real-world object;
determine a plurality of angular values based on the plurality of real-world object parameters of the at least one real-world object; and
detect the at least one real-world object based on the plurality of angular values.

13. The HMD device as claimed in claim 8, wherein the one or more instructions, when executed by the at least one processor individually or collectively, cause the HMD device to:
obtain data generated by external devices in a geographical area;
detect the content; and
detect the at least one activity of the user based on the data generated by the external devices in the geographical area and the content.

14. The HMD device as claimed in claim 8, wherein the one or more instructions, when executed by the at least one processor individually or collectively, cause the HMD device to:
detect initiation of the at least one activity of the at least one real-world object based on stored actions of the at least one real-world object in a geographical area;
obtain a safe zone of the at least one real-world object within the geographical area to perform the at least one activity based on the stored actions of the at least one object in the geographical area and a depth perception in the environment; and
determine the degree of collision the at least one real-world object with the range of movements of the user based on the safe zone.

15. A non-transitory computer-readable storage medium storing instructions, wherein the instructions, when executed by at least one processor, cause a head-mounted display (HMD) device to perform the method of claim 1.
